(19) United States
(12) Patent Application Publication
(10) Pub. No.: US 2026/0310426 A1
(43) Pub. Date: Oct. 8, 2026

(54) Automated Tool Generation for Machine-Learned Model

(71) Applicant: Google LLC, Mountain View, CA (US)

(72) Inventors: Xuezhi Wang, New York, NY (US); Dengyong Zhou, Redmond, WA (US); Tianle Cai, Princeton, NJ (US); Xinyun Chen, Berkeley, CA (US)

(21) Appl. No.: 19/485,194

(22) PCT Filed: May 17, 2024
(86) PCT No.: PCT/US2024/029936

§ 371 Date: Nov. 17, 2025

Related U.S. Application Data
(60) Provisional application No. 63/502,882, filed on May 17, 2023.

(51) Int. Cl. G06F 8/35; G06F 11/3604

(52) U.S. Cl. CPC G06F 8/35; G06F 11/3604

(57) ABSTRACT

An example method includes receiving, by a computing system, a tool request for a tool for performing a task. The example method includes generating, by the computing system and using a primary machine-learned model, the tool based on the tool request by generating tool code. The example method includes validating, by the computing system, the tool. The example method includes outputting, by the computing system, the tool to a tool repository that is accessible by a toolkit interface of a downstream system to use the tool in conjunction with a secondary machine-learned model.

### PRIORITY

This application claims priority to and the benefit of U.S. Provisional Patent Application No. 63/502,882 (filed May 17, 2023). U.S. Provisional Patent Application No. 63/502,882 is hereby incorporated by reference herein in its entirety.

### FIELD

The present disclosure relates generally to machine learning processes and machine-learned devices and systems. More particularly, the present disclosure relates to implementing machine-learned models to generate tools for other machine-learned models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

In one example aspect, the present disclosure provides an example computer-implemented method. The example method can include receiving, by a computing system, a tool request for a tool for performing a task. The example method can include generating, by the computing system and using a primary machine-learned model, the tool based on the tool request by generating tool code. The example method can include validating, by the computing system, the tool. The example method can include outputting, by the computing system, the tool to a tool repository that is accessible by a toolkit interface of a downstream system to use the tool in conjunction with a secondary machine-learned model.

In one example aspect, the present disclosure provides another example computer-implemented method. The example method can include receiving, by a computing system and from a downstream system implementing a secondary machine-learned model, a request for a tool for performing a task. The example method can include determining, by the computing system, that a tool cache does not contain the tool. The example method can include providing, by the computing system and using a tool request, an instruction to a primary machine-learned model to generate the tool. The example method can include receiving, by the computing system, the tool from the primary machine-learned model. The example method can include adding, by the computing system, the tool to the tool cache. The example method can include outputting, by the computing system, the tool to the downstream system.

In one example aspect, the present disclosure provides another example computer-implemented method. The example method can include obtaining, by a computing system, an input. The example method can include determining, by the computing system and using a secondary machine-learned model, to invoke a tool to perform a task corresponding to the input, wherein the tool was generated by a primary machine-learned model. The example method can include generating, by the computing system and using the secondary machine-learned model, a tool input. The example method can include executing, by the computing system, the tool in a tool execution environment to process the tool input and generate a tool output. The example method can include returning, by the computing system, an output based on the tool output.

In one example aspect, the present disclosure provides example non-transitory computer readable media storing instructions that are executable by one or more processors to cause a computing system to perform the example methods.

In one example aspect, the present disclosure provides an example computing system including the example non-transitory computer readable media. The example computing system can include the one or more processors.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures.

FIG. 1 is a block diagram of an example system for implementing a tool generation pipeline according to example aspects of some embodiments of the present disclosure.

FIG. 2 is a block diagram of an example system for implementing a tool generation pipeline according to example aspects of some embodiments of the present disclosure.

FIG. 3 is a block diagram of an example system for implementing a tool generation pipeline according to example aspects of some embodiments of the present disclosure.

FIG. 4 is a flow chart diagram illustrating an example method for training a machine-learned model according to example implementations of aspects of the present disclosure.

FIG. 5 is a block diagram of an example processing flow for using machine-learned model(s) to process input(s) to generate output(s) according to example implementations of aspects of the present disclosure.

FIG. 6 is a block diagram of an example sequence processing model according to example implementations of aspects of the present disclosure.

FIG. 7 is a block diagram of an example technique for populating an example input sequence for processing by a sequence processing model according to example implementations of aspects of the present disclosure.

FIG. 8 is a block diagram of an example model development platform according to example implementations of aspects of the present disclosure.

FIG. 9 is a block diagram of an example training workflow for training a machine-learned model according to example implementations of aspects of the present disclosure.

FIG. 10 is a block diagram of an inference system for operating one or more machine-learned model(s) to perform inference according to example implementations of aspects of the present disclosure.

FIG. 11 is a block diagram of an example networked computing system according to example implementations of aspects of the present disclosure.

FIG. 12 is a block diagram of an example computing device according to example implementations of aspects of the present disclosure.

FIG. 13 is a block diagram of an example computing device according to example implementations of aspects of the present disclosure.

FIG. 14 is a flow chart diagram illustrating an example method for generating tools using a machine-learned model according to example implementations of aspects of the present disclosure.

FIG. 15 is a flow chart diagram illustrating an example method for obtaining, caching, and distributing tools generated by a machine-learned model according to example implementations of aspects of the present disclosure.

FIG. 16 is a flow chart diagram illustrating an example method for using tools generated by a machine-learned model according to example implementations of aspects of the present disclosure.

### DETAILED DESCRIPTION

Example aspects of the present disclosure generally relate to a tool generation pipeline for generated, distributing, and implementing tools for use by machine-learned models. Machine-learned models can use tools to execute tasks. Using tools to perform tasks can expand the capability of the machine-learned models beyond native capacity. For instance, a sequence-to-sequence machine-learned model can use tools to algorithmically perform logic, mathematical, or other tasks with greater consistency by leveraging the deterministic repeatability of traditional software programs. As another example, a sequence processing model can use tools to interface with other computing systems that can require structured interactions (e.g., via an API). Further, tools can in some scenarios be executed with lower computational expense (e.g., less power, less memory, fewer processing cycles, etc.) than a large language model, such that using a tool to perform a task can improve operating efficiency.

However, traditionally, tools have been manually created. As such, the advantages of tools were only obtained after an initial investment of hand-coding the tool for deployment, introducing manual labor, time delay, and generally limiting the responsiveness of the system to new tasks.

Advantageously, example implementations of the present disclosure can use machine-learned models to generate tools for other machine-learned models. For instance, a primary, highly expressive machine-learned model can apply its generative power to write code for tools to perform a particular task. The primary model can be called a “tool maker” model. For instance, a language model can generate code in a programming language that defines a computer program for performing a task. That generated tool can be called by a secondary, lightweight model that can leverage the knowledge distilled into the generated tool to improve its performance on that particular task beyond what such a lightweight model would otherwise be capable of performing. The secondary model can be called a “tool user” model.

In some examples, using a sequence processing model as a tool maker can be divided into two stages: 1) tool making: a powerful yet more expensive model serves as the tool maker to generate generic and reusable tools from a few demonstrations; 2) tool using: a lightweight and cheaper model serves as the tool user to use the tool to solve various instances of the task. An example tool-making stage can be further divided into three sub-stages: (i) tool proposing: the tool maker makes an attempt to generate the tool (e.g., a Python function) from a few training demonstrations; if the tool is not executable, report the error and generate a new one (fix the function); (ii) tool verification: the tool maker runs unit tests on validation samples; if the tool does not pass the tests, report the error and generate new tests (fix the function calls in unit tests); and (iii) tool wrapping: wrapping up the function code and the demonstrations of how to convert a question into a function call from unit tests, preparing usable tools for tool user.

More particularly, the second stage can involve a lightweight and cost-effective model to serve as the tool user. The tool user's role can be to utilize the verified tool to solve various instances of the task. The prompt for this stage can be the wrapped tool which contains the function for solving the task and demonstrations of how to convert a task query into a function call. With the demonstrations, tool user can then generate the required function call in an in-context learning fashion. The function calls are then executed to solve the task. Optionally, postprocessing can be applied to convert the output to match the required format of the task, such as options for multiple-choice questions.

Advantageously, the tool-making stage, including tool proposing, verification, and wrapping, can be performed only once for each type of task. The resulting tools can then be reused for all instances of that task. In some implementations, then, using the generated tools can be significantly more efficient and cost-effective than using a powerful model alone.

The tool maker system can validate the tool. The generated tools can be validated based on some example inputs and outputs for all or a portion of the tool (e.g., unit tests). For example, an example task instruction (e.g., a question) can be input to the generated tool and the output can be compared to an example task output (e.g., an answer). Based on this comparison the generated tool can be validated.

The tool maker model can debug the tool code. The tool maker model can process the generated tool code and a description of any errors associated with execution of the tool code and identify and correct any errors in the tool code the generate the tool. Validation can be repeated to determine if the corrected tool is operational.

The tool can be generated using output sampling. For instance, multiple variations of the tool code can be sampled from the output layer(s) of the primary model. The variants can each be evaluated against the validation standard(s). A variant that performs well (e.g., the best) can be selected as the tool code for the tool.

The tools can be standalone programs written to perform a task. The tools can be functions designed to be called within other programs. For instance, the tool user model can generate a script that calls the tool to perform a task.

The tool maker system can package the tool with instructions for using the tool. For instance, the tool maker system can package the tool with demonstration(s) of how to call the tool to perform the task. For example, the tool maker system can package the tool with demonstration(s) that contain example tasks and example tool inputs corresponding to the example tasks. For example, the tool maker system can package the tool with demonstration(s) that contain example programs that call the tool (e.g., as a function).

In some real-world scenarios, tasks can arrive in a sequential stream. To address this, a dispatcher can be used that decides whether to engage the tool user or tool maker for each incoming task. An example dispatcher effectively contributes to creating a functional cache—it discerns new tasks that cannot be resolved with existing tools, thereby triggering the tool maker to generate appropriate tools for these tasks. An example dispatcher maintains a repository of existing tools crafted by the tool maker in the format of function APIs. Upon receipt of a new task instance, the example dispatcher first attempts to locate a compatible tool within the cache. If such a tool is present, the example dispatcher assigns the instance and corresponding tool to the tool user for use. However, if no suitable tool is available, the example dispatcher identifies this as a novel task, either generating a tool for it with a powerful model or, if necessary, queuing the request for tool generation by a human developer.

The present disclosure addresses technical problems associated with the efficiency and effectiveness of computational processes in machine learning environments. Traditionally, machine learning models, especially large language models (LLMs), use substantial computational resources for training and operation, which can lead to high operational costs and significant latency in response times. This is particularly problematic in scenarios where these models are used to generate solutions or outputs in real-time or near-real-time applications.

This problem is exacerbated when similar or identical tasks are repeatedly processed by high-resource-consuming machine learning models. This not only strains computational resources but also results in inefficient system performance, thereby increasing both the time and energy required for task completion. Furthermore, using probabilistic machine-learned models to perform rote, repetitive tasks can introduce possible sources of error due to the possibility of randomly sampling incorrect output values.

Furthermore, the management of these models often lacks flexibility in task distribution and resource allocation, leading to underutilization of available computational resources. For instance, the same high-resource model might be used for both complex and relatively simple tasks, which could otherwise be handled by less resource-intensive models without compromising output quality. This approach fails to optimize the use of computational resources across different tasks, leading to unnecessary computational expenses and energy consumption.

Example implementations of the present disclosure can advantageously solve such problems by introducing a tool generation and application pipeline that utilizes a dual-model approach. A primary machine-learned model can generate tools for specific tasks, and a secondary, less resource-intensive model can apply these tools to perform tasks. This approach not only reduces the redundancy of computational efforts by allowing for the reuse of tools across similar tasks but also optimizes resource allocation by appropriately distributing tasks between the two models based on complexity and resource requirements. Additionally, the introduction of a cache for storing and reusing tools can further enhance the efficiency of the system by reducing the need for repeated tool generation, thereby significantly lowering latency and computational load on the system.

A technical effect of example implementations of the present disclosure is increased system performance at tasks, thereby improving the functioning of computers implementing such techniques. For instance, for a given model size, the use of a tool can increase performance on certain tasks. By providing a mechanism for the automatic generation and distribution of tools for novel tasks, more tools can be used for more tasks by more models, thereby increasing overall performance over traditional systems in which tools must be manually developed and distributed.

A technical effect of example implementations of the present disclosure is decreased latency, thereby improving the functioning of computers implementing such techniques. For instance, for a given model size, the use of a tool can increase performance on certain tasks. As such, for a target level of performance, a smaller model may be used (e.g., fewer parameters, fewer layers, lower-bitwidth parameters, etc.). Smaller models can generally be executed more quickly using a given amount of compute. By providing a mechanism for the automatic generation and distribution of tools for novel tasks, more tools can be used for more tasks by more models, thereby facilitating the widespread use of smaller machine-learned models, allowing for quicker performance of tasks across many different systems.

A technical effect of example implementations of the present disclosure is increased energy efficiency in performing operations using machine-learned models, thereby improving the functioning of computers implementing such techniques. For instance, example implementations can provide for more energy-efficient runtime execution or inference by facilitating the use of smaller models to perform tasks. For instance, a larger tool maker model can run a few times to generate a tool, but once the tool is generated the knowledge distilled into the tool can be repeatedly leveraged by many smaller models performing inference at various endpoint applications. These smaller models can be more energy efficient to execute at runtime/inference as compared to the large tool maker model. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, the tool generation pipeline of the present disclosure can provide for a given level of functionality of a smaller model to be obtained in fewer training iterations, thereby expending a smaller energy budget, because tools can be used to augment the power of the model with respect to various tasks, thereby freeing the expressivity of the model parameters for other purposes. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO₂ released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Reference now is made to the figures, which provide example arrangements of computing systems, model structures, and data flows for illustration purposes only.

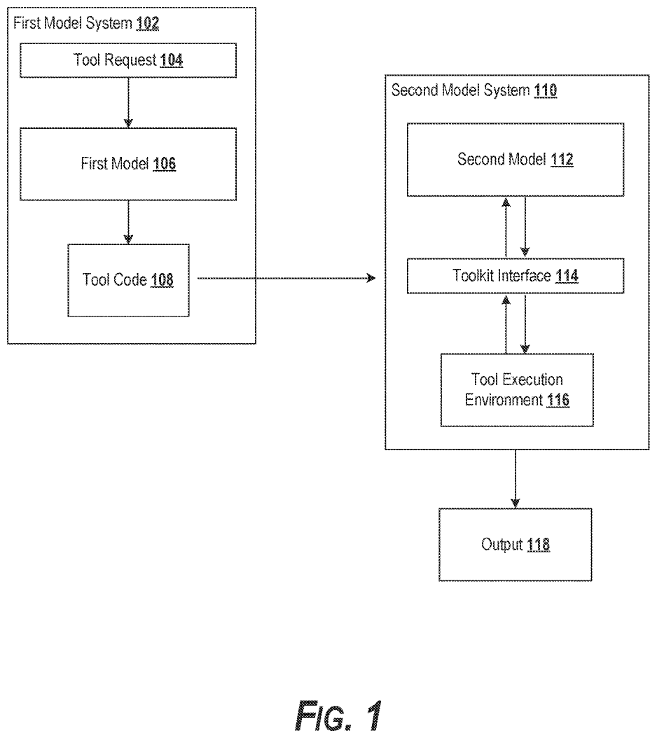

FIG. 1 illustrates an example automated tool generation pipeline. A first model system 102 (e.g., a tool maker system) can input a tool request 104 to a first model 106 to generate tool code 108. Tool code 108 can be passed to second model system 110 (e.g., a tool user system). Second model system 110 can implement second model 112. Second model 112 can interact with toolkit interface 114 to implement tool code 108 in a tool execution environment 116. Toolkit interface 114 can obtain results from the tool execution environment 116. Based on the results (e.g., a tool output generated by a tool), second model system 110 can output an output 118.

The first model system 102 can be a tool maker system configured for generating new tools. This system can be designed to generate tools that are invoked by other systems (e.g., responsive to instructions from other machine-learned models), thereby enabling those other systems or models to perform specific tasks more efficiently. First model system 102 can include one or multiple computing systems. These computing systems can be arranged in a variety of configurations and can include servers, personal computers, cloud-based computing resources, or any combination thereof.

First model system 102 can be accessible via an Application Programming Interface (API). This API can facilitate interaction between first model system 102 and external systems or users. Through this API, users or systems can submit tool requests, receive updates on the tool generation process, and retrieve the generated tool codes. The API can support various protocols and data formats to ensure compatibility and ease of integration with diverse external systems. Additionally, the API can provide secure access to the first model system 102, implementing standard security measures such as authentication, encryption, and data integrity checks to protect the data and the processes involved in tool generation.

Tool request 104 can be a structured query or command that specifies the requirements or characteristics of the tool that needs to be generated. This request can include a variety of parameters such as the type of task the tool is intended to perform, the programming language in which the tool should be coded, performance constraints, and any specific algorithms or methodologies to be incorporated.

Tool request 104 can be generated by an external system or a user interface that interacts with first model system 102 via an API. For instance, second model system 110 can generate tool request 104 based on a request to perform a task. First model system 102 can parse this request and translate it into a format that can be understood and processed by the first model 106.

Tool request 104 can also be formatted in various ways to ensure compatibility with different types of computing environments. It can be structured as a JSON object, an XML file, or a simple text query, depending on the interfacing requirements of the system it interacts with. This flexibility can allow the tool request to be easily integrated into existing workflows and systems without necessitating significant modifications to existing infrastructure.

Tool request 104 can include authentication information to ensure that the request is being made by an authorized entity. This can include API keys, user IDs, or cryptographic tokens that verify the identity of the requester. This can help in maintaining the security and integrity of the tool generation process, ensuring that only authorized requests are processed.

Tool request 104 can be designed to support batch processing, where multiple tool requests can be sent simultaneously. This can be particularly useful in environments where tools are frequently needed on a large scale, such as in cloud computing platforms or large corporate networks.

Tool request 104 can also include priority indicators that suggest the urgency or importance of the request. This can allow the system to prioritize tool generation based on the needs of the business or user, ensuring that critical tools are developed and delivered in a timely manner.

Tool request 104 can allow for the specification of dependencies or prerequisites available for the tool's operation. This can include libraries, frameworks, or other tools that are in place on the requesting system that can be used by the newly requested tool. This can help in ensuring that the generated tool is compatible with the requesting system and can operate smoothly once deployed. Tool request 104 can support version control, allowing requesting systems to specify if they need a tool compatible with particular versions of software or systems.

Tool request 104 can be configured to include test cases or scenarios that help in validating the functionality of the tool once developed. This can aid in the quality assurance process, ensuring that the tool not only meets the technical specifications outlined in the request but also performs as expected in practical scenarios.

Tool request 104 can also include specific performance benchmarks, such as processing speed or accuracy. This information can be passed to first model 106 to help generate tool code 108 that achieves the benchmarks. This benchmark information can also be used during post-generate testing and validation to ensure that tool code 108 satisfies some set of minimum requirements.

Tool request 104 can include indicators of the preferred language for the tool.

Tool request 104 can include metadata that describes the context or the environment in which the tool will be used. This metadata can help first model 106 to better understand the operational constraints and optimize tool code 108 accordingly. For example, if the tool is intended for use in a resource-constrained environment, tool request 104 can specify limitations on memory usage or processing power, which can guide first model 106 in creating a more efficient and suitable tool.

Tool request 104 can also specify the level of validation or testing required before the tool is considered ready for deployment. This can include unit tests, integration tests, or performance benchmarks that the tool needs to pass. By including these specifications in the tool request 104, the system can automate not only the generation of the tool but also its validation, thereby streamlining the entire development pipeline from conception to deployment.

First model 106 can receive inputs based on tool request 104 that cause first model 106 to generate tool code 108. For instance, first model system 102 can input to first model 106 an instruction or prompt configured to cause first model 106 to generate tool code 108. An example query for a tool written in Python can include:

Please write a generic Python function to solve this type of problem using only standard python libraries. The output of the function can later be converted to the answer (option for multiple choice question). All the function should be wrapped by
′″python
′″

Generally, first model 106 can include a sequence processing model that generates a sequence output based on an input sequence. First model 106 can include a language model, such as may be called a “large language model” or “LLM.” For example, first model 106 can generate a sequence of tokens corresponding to code for tool code 108 based on an input sequence of instructions (e.g., natural language instructions, structured instructions, etc.).

First model 106 can be specifically fine-tuned for code generation tasks, which can enhance its capability to generate highly functional and optimized tool code. This fine-tuning process can involve training first model 106 on a diverse dataset of programming tasks and solutions, which can enable the model to learn various coding styles, algorithms, and optimization techniques. The training data can include examples from multiple programming languages, thereby broadening the model's applicability across different technology stacks and development environments. This fine-tuning can also involve reinforcement learning techniques where the model can receive feedback on the functionality and efficiency of the code it generates, which can further refine its code generation capabilities.

First model 106 can be designed to support multi-language code generation, which can allow it to generate tool code in various programming languages as per the specifications mentioned in the tool request. This capability can be facilitated by the model's architecture that can include multiple output layers, each fine-tuned for a specific programming language. Such a design can enable first model 106 to switch context easily depending on the tool request, thereby enhancing its flexibility and utility in a multi-technology development environment. Multi-language support can also involve the model being trained on language-specific idioms and best practices, which can help in generating not only functional but also idiomatic and efficient code.

First model 106 can incorporate error detection and correction mechanisms during the code generation process, which can enhance the reliability of the generated tool code. These mechanisms can involve syntactic and semantic analysis tools that can detect potential errors in the generated code, such as type mismatches, syntax errors, or logical flaws. Upon detection, first model 106 can automatically revise the generated code to rectify these errors, or it can flag these issues for manual review, depending on the configuration. This capability can be critical in ensuring that the tool code generated by first model 106 is not only functional but also robust and ready for deployment in a production environment.

First model 106 can include functionality to enforce correct syntax during the decoding of new tokens, which can be particularly useful when generating tool code 108. This capability can ensure that the tool code generated is syntactically correct according to the programming language specifications in which the tool is written. For instance, when generating tool code in Python, first model 106 can enforce proper indentation, appropriate use of colons, and correct structuring of loops and conditionals. This enforcement can be achieved through an internal syntax validation mechanism within first model 106, which can parse a buffer of one or more generated tokens to confirm their adherence to language-specific syntax rules before finalizing the output. This internal syntax validation mechanism can use a smaller syntax model that has been trained to recognize syntax errors. The internal syntax validation mechanism can use one or more heuristics or hand-coded rules for error checking.

First model 106 can also be configured to utilize a syntax error correction algorithm that may operate in real-time as tokens are being decoded. This algorithm can identify common syntax errors and automatically suggest or implement corrections without manual intervention. For example, if a closing parenthesis is missing in a function call, the algorithm can detect this omission and insert the closing parenthesis at the appropriate position in the token sequence. This feature can enhance the robustness of the tool generation process by minimizing the incidence of syntax-related errors in the generated tool code.

First model 106 can also support customizable syntax rules, which can be specified by the user or system administrator according to the specific requirements of the development environment or the target application of the tool code. These customizable rules can allow for the enforcement of coding standards and conventions that go beyond basic syntactic correctness, such as naming conventions, comment styles, and file organization. This flexibility can make first model 106 adaptable to a wide range of coding practices and can help ensure that the generated tool code seamlessly integrates with existing codebases and development workflows.

First model 106 can generate multiple different variations of tool code 108. For instance, first model 106 can use output sampling, where multiple variations of tool code portions are sampled from a probability distribution generated by the output layers of the primary machine-learned model. This method can allow for the exploration of a diverse set of potential solutions to a given task, as each variant of the tool code represents a different approach to solving the problem specified in the tool request. The variants generated can each be evaluated against predefined validation standards, which may include performance metrics such as accuracy, efficiency, or compliance with specific operational requirements. By evaluating multiple variants, the system can identify which version of the tool code best meets the desired criteria for the task at hand. The variant that exhibits the best performance during this evaluation phase can then be selected as the tool code to be utilized in the tool. This approach can enhance the likelihood of obtaining a highly effective tool by comparing multiple potential solutions.

Output sampling can be performed in parallel across independent decoding streams. For instance, first model 106 can perform parallel decoding of tool code portions (e.g., tokens of coding language) along a batch dimension. Each decoding stream can autoregressively generate a different variant of the tool code in parallel. By employing parallel processing, the time required to generate and evaluate multiple tool code variants can be significantly reduced, thus speeding up the overall tool generation process. This parallelization can leverage the computational power of modern processing architectures, allowing for efficient scaling as the complexity or number of tool requests increases. By generating multiple variants, the diversity of candidate tools can be improved, increasing robustness to failures or errors in individual candidates.

For example, first model 106 can implement temperature sampling to produce diverse tool code variants. Temperature sampling can adjust how an output probability distribution is sampled to obtain tool code portions (e.g., tokens of coding language). A higher temperature can provide more randomness into the output. A lower temperature can decrease variability. For instance, low-temperature sampling can correspond to greedy sampling, in which only the most likely next token is selected from the generated output distribution.

Tool code 108 can be or include a programming language, markup language, database or query language, scripting language, or any other computer instruction schema based on sequences of input characters. An example programming language includes Python, although other programming languages can be used.

Tool code 108 can be generated in a variety of programming languages, depending on the specific requirements of the task for which the tool is intended. The first model system 102 can receive inputs specifying the desired programming language through tool request 104. For example, if the task involves data manipulation and analysis, Python might be selected due to its extensive libraries and community support for such tasks. Alternatively, if the task requires high-performance computing, tool code 108 might be generated in C++ to leverage its efficiency and speed. The selection of the programming language can be dynamically determined by first model system 102 based on the nature of the task, the performance requirements, or explicit specifications indicated in tool request 104.

Tool code 108 can also be tailored to operate within different runtime environments. Inputs to the first model 106, generated based on tool request 104, can specify the target runtime environment, whether it be a virtual machine, a containerized environment, or directly on physical hardware. First model system 102 can select the appropriate runtime environment by analyzing the task's requirements and the constraints of the deployment environment. For instance, a containerized environment might be chosen for its portability and ease of deployment, while a direct hardware execution might be preferred for tasks that demand maximum performance. First model system 102 can select the runtime environment based on a specific specification in tool request 104.

Tool code 108 can be designed to suit different software architectures. This capability ensures that the generated tool can integrate seamlessly with existing systems and infrastructures. The architecture-specific details can be included in the inputs to the first model 106, which might specify whether the tool should be optimized for a microservices architecture, a monolithic architecture, or even serverless computing. First model system 102 can select the most suitable architecture based on these inputs, the complexity of the task, and the scalability requirements. First model system 102 can select the architecture based on a specific architecture specification in tool request 104.

First model system 102 can include a verification module that can be responsible for verifying the functionality and correctness of tool code 108 after it has been generated. This verification module can operate by implementing a series of automated tests that can assess whether the tool code 108 performs as expected based on predefined criteria or benchmarks. These tests can include unit tests, integration tests, and system tests, which can collectively ensure that the tool code 108 is robust and ready for deployment. For instance, unit tests can be used to check individual components or functions within the tool code 108 for correct behavior, while integration tests can verify the interactions between these components. System tests can evaluate the performance of the entire tool under conditions that mimic real-world operational scenarios.

First model system 102 can also utilize a simulation environment where tool code 108 can be executed to observe its behavior in a controlled setting. This simulation can provide insights into how the tool code 108 interacts with other software or hardware systems, which can be helpful for ensuring compatibility and performance standards. The simulation can include virtual machines or containers that replicate the target deployment environment, thereby providing a realistic backdrop for testing. The simulation can allow for stress testing, where the tool code 108 can be subjected to extreme operational conditions to evaluate its resilience and stability. This can include scenarios with high data loads, rapid input/output operations, or concurrent access by multiple users.

First model system 102 can further incorporate a feedback mechanism where the results of the verification tests can be analyzed to identify any areas of improvement. This feedback can be used to fine-tune the tool code 108, enhancing its functionality and efficiency. The feedback mechanism can include logging tools that record the execution flow and output of the tool code 108, providing detailed data that can be used to diagnose issues. Additionally, the feedback can be derived from runtime metrics such as execution time, memory usage, and processor load, which can provide quantitative data on the performance of the tool code 108.

Test data can be fed back into first model 106, which can use the information to adjust the code generation process, potentially increasing the quality of subsequent outputs. For instance, first model system 102 can provide iterative refinement of tool code 108. After initial verification, tool code 108 can be revised based on the outcomes of the tests and simulations. These revisions can be retested to ensure that all identified issues have been addressed, and the tool code 108 meets all specified requirements. This iterative process can continue until the tool code 108 is validated to be of high quality and ready for deployment.

First model system 102 can use first model 106 to validate the tool. For example, first model 106 can be provided with an instruction to formulate tests from a set of validation examples. For instance, an example instruction could include:
Write unit tests to verify the correctness of the function on the questions above using the following format:
′″python
{parse the question into the arguments of the function}
{call the function and save the return value in a variable named “ret”}
{for multiple choice question, parse the options}
{convert the return value “ret” to the answer (if the question is a multiple choice question, convert to an option) and save it in a variable named “ans”, otherwise}
{assert ans==the provided answer (if the question is a multiple choice question, assert ans==option)}
′″

First model system 102 can include functionality to wrap or package tool code 108 for distribution, which can enhance the usability and accessibility of the tools generated. This model system can be configured to automatically package the generated tool code into a distributable format, such as a software library or an executable file, depending on the requirements of the downstream systems that will utilize the tool.

Packaging the tool code can include generating a set of instructions to accompany the tool code. The instructions can be configured as at least a portion of a prompt for input to second model 112. For instance, first model 106 can be provided with an instruction or prompt to construct a prompt for second model 112 to use when implementing the tool. An example prompt could include:
Success! The function is correct. We will need to summarize the function and use cases up for further use. Please extract the information from the history in the following format:
Here is a function to solve a class of problems:
′″python
{the function, including necessary imports}
′″
Use cases:
Question: {question (including options)}
Solution
′″ python
{parse the question into the arguments of the function}
{call the function and save the return value in a variable named “ret”}
{for multiple choice question, parse the options}
{convert the return value “ret” to the answer (if the question is a multiple choice question, convert to an option) and save it in a variable named “ans”, otherwise}
′″
Do this for all the questions in the verification step.

In this manner, for instance, first model 106 can generate instructions that second model 112 can follow to invoke the tool. The instructions can include example inputs and outputs so that second model 112 can understand the tasks that the tool performs and the necessary inputs for implementing the tool.

First model system 102 can support the distribution of the packaged tool code through various channels. This can include uploading the packaged tool to a centralized repository where it can be accessed by downstream systems, or distributing it directly to specific users or systems through a direct download. Additionally, first model system 102 can be configured to support automated deployment mechanisms, such as continuous integration and continuous deployment (CI/CD) pipelines, which can enable the tool code to be automatically deployed to production environments as soon as it is packaged.

Second model system 110 can be the same or different as first model system 102. Second model system 110 can be implemented on the same computing device(s) as first model system 102 or on different computing device(s) from first model system 102. Second model system 110 can be in a client-server relationship with first model system 102. Second model system 110 can submit tool requests 104 to first model system 102 (e.g., via an API) and receive generated tools from first model system 102.

Second model 112 can include a language model, such as may be called a “large language model” or “LLM.” Second model 112 can be smaller than first model 106, such as by having fewer parameters, fewer layers, lower-bitwidth (e.g., quantized) parameters, etc. For example, second model system 110 can be a resource-constrained device. The smaller size of second model 112 can enable it to perform tasks more quickly and with less computational overhead than first model 106. This can be particularly advantageous in scenarios where rapid response times are crucial, or where computational resources are limited.

Second model 112 can be designed to leverage tools generated by first model 106, allowing it to perform tasks that may be beyond its native capabilities. By using these tools, second model 112 can effectively extend its functionality and improve its performance on specific tasks without the need for extensive retraining or increasing its size. This can be especially beneficial in environments where adaptability to new tasks is required but where the computational cost of using a larger model is prohibitive.

Second model 112 can be implemented using lightweight language models, often referred to as small language models (SLMs), which are characterized by their reduced computational requirements. These models can be particularly beneficial for on-device execution where computational resources, power consumption, and memory usage are limited. By utilizing SLMs, second model 112 can operate efficiently on various devices, including smartphones, tablets, and embedded systems, thereby enabling broader accessibility and utility. The deployment of SLMs can facilitate real-time processing and responsiveness, which are helpful for applications requiring immediate feedback, such as interactive user interfaces or real-time monitoring systems.

Second model 112 be a small language model that performs one or more tasks by executing tools (e.g., tools generated by first model system 102). Tools can be created by a more powerful primary model as described in the present disclosure. This approach can allow second model 112 to achieve higher performance levels on specific tasks than would typically be possible with SLMs alone. For instance, the tool could encapsulate complex algorithms or data processing techniques that the SLM would not be capable of handling directly (or reliably) due to its limited computational capacity (e.g., limited context size, limited world knowledge, etc.). As a result, second model 112 can extend the capabilities of on-device applications without the need for constant communication with cloud-based systems, thus preserving bandwidth and reducing latency.

Second model 112 can also benefit from the use of SLMs by enhancing user privacy and data security. Since SLMs can process data directly on the device, sensitive information does not need to be transmitted to external servers for processing. This can be particularly advantageous in applications dealing with personal data, such as health monitoring or personal assistants.

Second model 112 can receive an input that describes available tools. The input can include a variety of metadata to aid in the selection and utilization of the appropriate tools for specific tasks. This input can be structured as a tool index, which may list all available tools along with their respective features, such as function signatures, input requirements, output formats, and possibly annotations on the intended use-case or performance metrics. The tool index can enable second model 112 to efficiently identify and select the most suitable tool for a given task based on the task's characteristics and requirements. An entry in the tool index for a given tool can be generated by first model 106 when generating the tool.

Second model 112 can, based on processing the tool index, generate a tool call that invokes one of the available tools listed in the input. The tool call can be constructed as a function call in a programming language, where second model 112 formulates the function arguments based on the input data associated with the task. The tool call can be constructed as a structured data object that conforms with a designated format for invoking external tools (e.g., consistent with a format used during training of second model 112).

For example, second model 112 can process an input to the model (e.g., a request to perform a task) and determine to initiate execution of a tool. For instance, second model 112 can be configured (e.g., trained, prompted) to identify what tool to use based on analysis of the input. Second model 112 can select a tool from a set of one or more available tools (e.g., a tool listing or index input to second model 112 in a prompt).

Toolkit interface 114 can include a program configured to facilitate tool use by second model 112. Toolkit interface 114 can input a list of available tools or other tool-related information to second model 112. Toolkit interface 114 can parse outputs of second model 112 to determine that a tool is being invoked and initiate execution of the tool.

Toolkit interface 114 can serve as an intermediary layer between the second model 112 and the tool execution environment 116. It can be configured to parse outputs from the second model 112, which may include specific commands or code snippets intended to invoke tool calls. The interface can analyze these outputs to discern any actionable items that correspond to tool usage instructions. Once a tool call is identified, toolkit interface 114 can initiate the corresponding tool execution by interfacing with the tool execution environment 116. This process can involve passing the necessary parameters and execution commands required to properly deploy the tool within the environment.

Toolkit interface 114 can be designed to provide feedback to second model 112 post tool execution. This feedback can include execution status, results of the tool operation, and any errors or exceptions encountered during the execution. By feeding this information back to second model 112, toolkit interface 114 can facilitate a continuous learning loop where the model can refine its output generation for future tool calls based on past execution outcomes.

Tool execution environment 116 can include a compiler, an interpreter, a sandbox, or other infrastructure for executing the tool code. Tool execution environment 116 can be configured to support various programming languages and technologies, which can allow it to accommodate the diverse range of tools that might be generated. For instance, if a tool is developed in Python, the execution environment can include the necessary Python runtime and libraries to execute the tool. Similarly, for tools developed in other languages like Java or C++, the environment can be equipped with the appropriate compilers and runtime systems. This flexibility can ensure that tools are executed in an environment that is optimized for their specific technological requirements, potentially enhancing the performance and reliability of tool execution.

Tool execution environment 116 can also be designed to be secure, ensuring that the execution of tools does not compromise the integrity or confidentiality of the data being processed. This can involve implementing security measures such as sandboxing, where each tool is executed in a separate, isolated environment to prevent it from accessing or interfering with other processes or data. Additionally, the execution environment can include security protocols such as code signing and execution monitoring to verify the authenticity of the tools and to monitor their behavior during execution. These security features can help in preventing malicious code execution and protecting the system from potential vulnerabilities.

Toolkit interface 114 can retrieve outputs from the tool from tool execution environment 116 and return the outputs to second model 112 for processing. For instance, second model 112 can receive an answer to a question and generate a natural language description of the answer or context for the answer.

In an illustrative example of the present disclosure, first model system 102 can receive a tool request 104 for a tool designed to perform signal processing on large-scale measurement datasets. This request can specify the need for a tool that can efficiently filter and analyze signal data to identify patterns or anomalies. The tool request 104 can be formatted in JSON and might include parameters such as the type of signals, the expected size of the datasets, and performance metrics like processing speed or accuracy.

Upon receiving tool request 104, first model system 102 can engage first model 106, which may be a highly expressive machine-learned model, to generate tool code 108. First model 106 can be trained or fine-tuned on a variety of programming tasks, including those specific to signal processing, allowing it to generate optimized and functional code. For example, first model 106 can generate Python code that implements a Fast Fourier Transform (FFT) algorithm to analyze the frequency components of the signal data. The generated Python code snippet might look like this:

```
import numpy as np
def process_signals(data):
  # Applying FFT to analyze frequencies
  frequencies = np.fft.fft (data)
  return frequencies
```

This tool code 108 can then be validated by first model system 102 using a series of automated tests, which can assess the functionality and performance of the code against predefined criteria such as accuracy in frequency analysis and execution speed. An example automated test can include generating a waveform using a combination of components with known frequencies and evaluating whether the returned frequencies from the tool match the known components. If the tool code 108 meets the specified benchmarks, it can be packaged with instructions on how to use the tool, including example inputs and expected outputs.

Second model system 110, which can include a secondary, lightweight machine-learned model such as second model 112, can then utilize the generated tool. Second model 112 can be smaller and designed for rapid execution, making it suitable for deployment in environments where real-time signal processing is required. Second model 112 can process instructions for using the generated tool (e.g., a prompt defining an input format, etc.). Second model 112 can generate an output that contains an invocation of process_signals. Toolkit interface 114 can parse the output and recognize the invocation. Toolkit interface 114 can initiate execution of process_signals using the inputs designated in the output of second model 112.

Toolkit interface 114 initiate the execution of the tool code 108 in the tool execution environment 116, which can be configured to support Python execution. The tool execution environment 116 can process the signal data using the provided FFT tool, and the results can be retrieved by toolkit interface 114 and returned to second model 112. Second model 112 can then process these results to generate a final output, such as a report on the signal analysis, which can be used for further decision-making processes.

### Example Wrapped Tool for Logical Deduction

```
Here is a function to solve a class of problems:
‘‘‘python
from itertools import permutations
def find_order(objects, constraints):
  for order in permutations(objects):
    valid = True
    for constraint in constraints:
      if not constraint(order):
        valid = False
        break
    if valid:
      return order
‘‘‘
Use cases:
Question: The following paragraphs each describe a set of
five objects arranged in a fixed order. The statements
are logically consistent within each paragraph. On a
shelf, there are five books: a white book, a green book,
a brown book, a gray book, and an orange book. The gray
book is to the right of the orange book. The green book
is the second from the right. The brown book is to the
right of the white book. The brown book is to the left of
the orange book.
Options:
(A) The white book is the third from the left
(B) The green book is the third from the left
(C) The brown book is the third from the left
(D) The gray book is the third from the left
(E) The orange book is the third from the left
Solution:
‘‘‘python
objects = [″white″, ″green″, ″brown″, ″gray″, ″orange″]
constraints = [
  lambda order: order.index(″gray″) >
    order.index(″orange″),
  lambda order: order.index(″green″) == len(order) − 2,
  lambda order: order.index(″brown″) >
    order.index(″white″),
  lambda order: order.index(″brown″) <
    order.index(″orange″)
]
ret = find_order(objects, constraints)
options = {
  ″A″: ″white″,
  ″B″: ″green″,
  ″C″: ″brown″,
  ″D″: ″gray″,
  ″E″: ″orange″
}
ans = [k for k, v in options.items( ) if v == ret [2]][0]
‘‘‘
Skip two more questions...
```

Toolkit interface 114 can parse out the python code and execute based on inputs provided by second model 112.

### Example Wrapped Tool for Tracking Shuffled Objects

```
Here is a function to solve a class of problems:
‘‘‘python
def square_dance(initial_partners, switches):
  # Create a dictionary to store the current partners
  current_partners = dict(initial_partners)
  # Iterate through the switches and update the current
  # partners
  for switch in switches:
    dancer1, dancer2 = switch
    partner1 = current_partners[dancer1]
    partner2 = current_partners[dancer2]
    # Swap the partners
    current_partners[dancer1] = partner2
    current_partners[dancer2] = partner1
  return current_partners
‘‘‘
Use cases:
Question: Alice, Bob, Claire, Dave, and Eve are on the same
team in a soccer match. At the start of the match, they
are each assigned to a position: Alice is playing
goalkeeper, Bob is playing left midfielder, Claire is
playing right winger, Dave is playing striker, and Eve is
playing center midfielder.
As the game progresses, pairs of players occasionally swap
positions. First, Alice and Claire trade positions. Then,
Alice and Bob trade positions. Then, Dave and Bob trade
positions. Then, Bob and Eve trade positions. Finally,
Dave and Eve trade positions. At the end of the match,
Eve is playing
Options:
(A) goalkeeper
(B) left midfielder
(C) right winger
(D) striker
(E) center midfielder
Answer: (C)
Solution:
‘‘‘python
initial_positions = [
  (″Alice″, ″goalkeeper″),
  (″Bob″, ″left midfielder″),
  (″Claire″, ″right winger″),
  (″Dave″, ″striker″),
  (″Eve″, ″center midfielder″),
]
switches = [
  (″Alice″, ″Claire″),
  (″Alice″, ″Bob″),
  (″Dave″, ,→ ″Bob″),
  (″Bob″, ″Eve″),
  (″Dave″, ″Eve″),
]
ret = square_dance(initial_positions, switches)
options = [
  ″goalkeeper″,
  ″left midfielder″,
  ″right winger″,
  ″striker″,
  ″center midfielder″
]
# Convert the return value to an option index (1-based)
ans = options.index(ret[″Eve″]) + 1
‘‘‘
Skip two more questions...
```

### Example Wrapped Tool for Dyck Language

```
Here is a function to solve a class of problems:
‘‘‘python
def complete_sequence(input_str):
  stack = [ ]
  closing_map = {
    ′(′: ′)′,
    ′[′: ′]′,
    ′<′: ′>′,
    ′{′: ′}′,
  }
  result = [ ]
  for char in input_str:
    if char in closing_map.keys( ):
      stack.append (char)
    elif char in closing_map.values( ):
      if stack and closing_map[stack[−1]] == char:
        stack.pop( )
      else:
        return ″Invalid sequence″
    else:
      return ″Invalid character″
  while stack:
    result.append(closing_map[stack[−1]])
    stack.pop( )
  return ′′.join(result)
‘‘‘
Use cases:
Question: Complete the rest of the sequence, making sure that
the parentheses are closed properly.
Input: ([[[{ }]]{<[<[{ }]>]>}
Answer: ])
Solution:
‘‘‘python
input_str = ″([[[{ }]]{<[<[{ }]>]>}″
ret = complete_sequence(input_str)
ans = ret
‘‘‘
Skip two more questions...
```

### Example Wrapped Tool for Word Sorting

```
Here is a function to solve a class of problems:
‘‘‘python
def sort_words_alphabetically(word_list):
  return sorted(word_list)
‘‘‘
Use cases:
Question: Sort the following words alphabetically: List:
conference apparition ignore dutton layperson coupe
superstitious westward turnoff messenger copra floruit
primitive implement
Answer: apparition conference copra coupe dutton floruit
ignore implement layperson messenger primitive
superstitious turnoff westward
Solution:
‘‘‘python
words1 = [
  ″conference″,
  ″apparition″,
  ″ignore″,
  ″dutton″,
  ″layperson″,
  ″coupe″,
  ″superstitious″,
  ″westward″,
  ″turnoff″,
  ″messenger″,
  ″copra″,
  ″floruit″,
  ″primitive″,
  ″implement″
]
ret1 = sort_words_alphabetically(words1)
ans1 = ″ ″.join(ret1)
‘‘‘
Skip two more questions...
```

### Example Wrapped Tool for Chinese Remainder Theorem

```
Here is a function to solve a class of problems:
‘‘‘python
def find_number(max_limit, divisors, remainders):
  for num in range(max_limit + 1):
    if all((num − remainder) %
      return num
  return None
‘‘‘
Use cases:
Question: There is a basket of no more than 1188877 durians.
If we divide them equally among 41 penguins, we have 17
left; if we divide them equally among 107 dinosaurs, we
have 42 left; if we divide them equally among 271
elephants, we have 260 left. How many durians are in the
basket?
Solution:
‘‘‘python
max_limit = 1188877
divisors = [41, 107, 271]
remainders = [17, 42, 260]
ret = find_number(max_limit, divisors, remainders)
ans = ret
‘‘‘
Skip two more questions...
```

### Example Wrapped Tool for Scheduling a Meeting

```
Here is a function to solve a class of problems:
‘‘‘python
from datetime import datetime, timedelta
def find_earliest_time_slot(
  a_availability,
  b_availability,
  meeting_duration
):
  a_availability = [(datetime.strptime(start, ′%
  b_availability = [(datetime.strptime(start, ′%
  for a_start, a_end in a_availability:
    for b_start, b_end in b_availability:
      latest_start = max(a_start, b_start)
      earliest_end = min(a_end, b_end)
      if (
        earliest_end − latest_start >=
        timedelta(minutes=meeting_duration
      ):
        return latest_start.strftime(′%
  return None
‘‘‘
Use cases:
Question: A and B want to schedule a 1-hour meeting together.
A's availability: 12:00 - 12:30, 13:00 - 13:30, 14:30 -
15:30, 17:30 - 18:00. B's availability: 09:00 - 11:00,
12:00 - 12:30, 13:00 - 13:30, 15:30 - 16:30, 17:30 -
18:00. What time slot works best? (if multiple, choose
the earliest one)
Answer: No time slot works.
Solution:
‘‘‘python
a_availability = [
  (′12:00′, ′12:30′),
  (′13:00′, ′13:30′),
  (′14:30′, ′15:30′),
  (′17:30′, ′18:00′)
]
b_availability = [
  (′09:00′, ′11:00′),
  (′12: 00′, ′12:30′),
  (′13:00′, ′13: 30′),
  (′15:30′, ′16:30′),
  (′17:30′, ′18:00′)
]
meeting_duration = 60
ret = find_earliest_time_slot(
  a_availability,
  b_availability,
  meeting_duration
)
ans = ret if ret else ″No time slot works.″
‘‘‘
Skip two more questions...
```

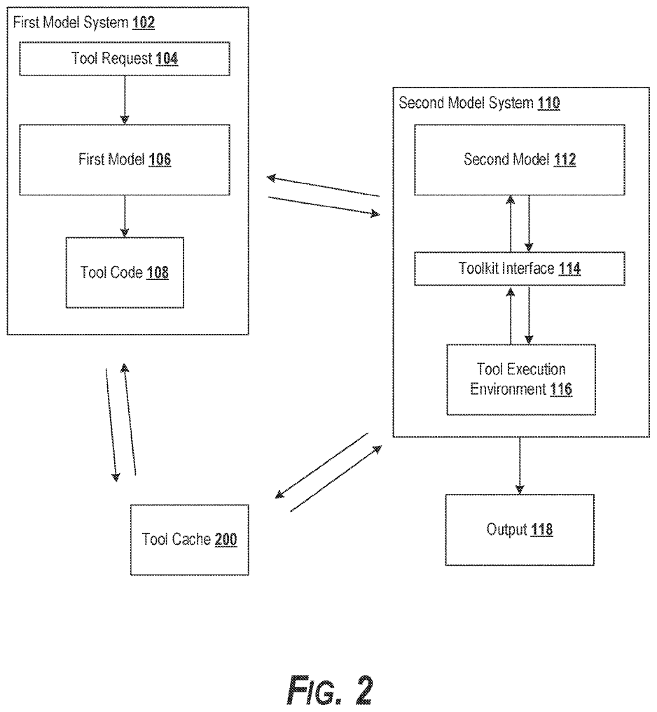

FIG. 2 illustrates an example automated tool generation pipeline. A tool cache 200 can be a repository of tools accessible by second model system 110 for obtaining tools to perform various tasks. For instance, second model system 110 can query tool cache 200 to determine whether there are any available tools to perform a task requested of second model system 110. If no matching tool is available, second model system 110 (or tool cache 200) can initiate generation of a new tool for that task by first model system 102. After generation, the generated tool can be stored in tool cache 200 to be available to other systems that query tool cache 200. The generated tool can be passed to second model system 110. The tool cache 200 can serve as a central repository where tools are stored following their creation by the first model system 102 and prior to their utilization by the second model system 110.

The tool cache 200 can be implemented using various data storage technologies, including but not limited to, relational databases, NoSQL databases, file systems, or cloud-based storage services. The choice of storage solution can depend on factors such as the expected size of the tool repository, the frequency of access, the required speed of retrieval, and the complexity of the tools being stored. For instance, a cloud-based storage solution can offer scalability and accessibility benefits, especially when the tool generation system is distributed across multiple geographic locations.

In operation, once the first model 106 within the first model system 102 generates tool code 108 based on a tool request 104, this tool code 108 can be transmitted to the tool cache 200. The process of storing tools in the tool cache 200 can include metadata tagging, which involves associating each tool with metadata that describes its function, the type of tasks it is suited for, its performance characteristics, and other relevant details. This metadata can facilitate efficient querying and retrieval of tools when needed by the second model system 110.

The tool cache 200 can support various functionalities such as addition, retrieval, update, and deletion of tools. When the second model system 110 requires a tool for performing a specific task, it can query the tool cache 200 to determine if an appropriate tool already exists. If so, the tool can be retrieved and sent to the second model system 110 via the toolkit interface 114. If no suitable tool is available, a new tool request 104 can be initiated to the first model system 102 to generate the required tool.

The integration of the tool cache 200 with the first and second model systems can be facilitated through an API that allows for seamless data exchange. This API can be designed to handle requests from the second model system 110 for tool retrieval, as well as notifications from the first model system 102 when new tools are added to the cache. The API can support various protocols and data formats to ensure compatibility with different types of model systems.

Furthermore, the tool cache 200 can implement advanced caching mechanisms such as least recently used (LRU) algorithms, which can help in managing the storage efficiently by removing seldom-used tools to free up space for more frequently needed tools. This can be particularly beneficial in environments where the variety and volume of tasks vary significantly over time.

Techniques such as indexing, partitioning, and replication can be employed to enhance the performance of tool retrieval operations. These optimizations can ensure that the latency between a tool request by the second model system 110 and the delivery of the tool is minimized, thereby not impeding the overall performance of the system.

Tool cache 200 can be configured to automatically update tools based on feedback from their use in the second model system 110. If a tool is found to be less effective or if there are new versions of the tools, the cache can be updated accordingly. This ensures that the tools stored in the cache can be optimized for performance and are up-to-date with the latest improvements.

The tool cache 200 can also support version control of tools, where multiple versions of a tool can be stored. This can be useful in scenarios where different versions of a tool may be optimal for different types of tasks or where backward compatibility needs to be maintained.

Tool cache 200 can communicate with multiple systems to obtain generated tools. Tool cache 200 can communicate with first model system 102 to obtain generated tools. Tool cache 200 can communicate with other systems to obtain generated tools. For instance, tool cache 200 can be associated with a platform to which multiple contributing systems can provide generated tools as described herein. Tool cache 200 can request different tools or different types of tools from different contributing systems. For instance, different contributing systems can be associated with different subject matter, different expertise, etc. Tool cache 200 can request generated tools from such systems based on a subject matter or expertise associated with a requested tool.

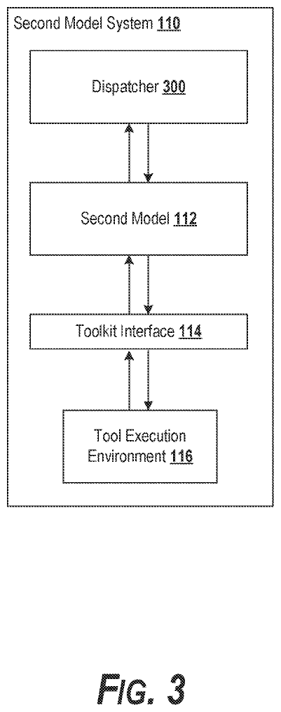

FIG. 3 depicts an example implementation of a second model system 110 that can include a dispatcher 300. Dispatcher 300 can be a processing layer that parses a requested task (e.g., parses an input to second model system 110) to determine what tool to use. Dispatcher 300 can be a machine-learned model. Dispatcher 300 can include a language model, such as may be called a “large language model” or “LLM,” or a “small language model,” or “SLM.” Dispatcher 300 can be smaller than first model 106 or second model 112, such as by having fewer parameters, fewer layers, lower-bitwidth parameters, etc. Dispatcher 300 can be the same as second model 112. Dispatcher 300 can be implemented by instructing second model 112 to analyze an input and determine what tool to use prior to being instructed to perform the task itself.

Dispatcher 300 can receive a stream of incoming task requests. Each request can be analyzed to determine its nature and the specific requirements it entails. This analysis can involve processing the task description evaluating it against descriptions of tasks that are already known and for which tools exist in the tool cache. Dispatcher 300 can maintain a database or a registry of task types and associated tools, which can be continuously updated as new tools are created and old ones are deprecated or improved. Dispatcher 300, when implemented as a sequence processing model, can process the registry (e.g., a tool index) to evaluate the relevance of a set of tools against a task request.

In scenarios where the task matches one for which a tool already exists, dispatcher 300 can direct the task to the second model 112, instructing it to use the specific tool from the tool cache. For instance, dispatcher 300 can provide a tool wrapper to second model 112. For instance, dispatcher 300 can provide a prompt that instruction second model 112 to populate an input data structure for invoking a particular tool.

If dispatcher 300 determines that the incoming task is of a new type or significantly different from those in the existing tool registry, it can initiate a tool creation process. This can include sending a tool request 104 to the first model system 102. The first model 106, acting as the tool maker, then generates the necessary tool code 108, which can be subsequently validated and, upon successful validation, added to the tool cache 200. This new tool can then be available for use by the second model system 110, not just for the current task but for any future tasks of the same type.

Furthermore, dispatcher 300 can be equipped with capabilities to learn from the outcomes of tasks it has routed. For instance, if a task routed to use an existing tool does not result in satisfactory outcomes, dispatcher 300 can record this event and use this information to adjust its future routing decisions. This learning process can be facilitated by feedback mechanisms where the performance of each task handling is evaluated against expected outcomes. The feedback can be added to a dispatcher prompt or can be used to update model parameters of dispatcher 300.

### Example Dispatcher Prompt

```
Here are several functions that can be used to solve some
task:
Task: logical_deduction_five_objects
API: find_order(objects, constraints):
  Finds the order of objects that satisfies a given set of
constraints.
  objects: A list of unique objects (strings) to be
ordered.
  constraints: A list of lambda functions that represent
the
constraints on the order of objects. Each constraint
should take the order of objects as input and return a
boolean value (True if the constraint is satisfied, False
otherwise).
  return: A tuple representing the order of objects that
satisfies all the constraints. If no such order exists,
the function returns None.
===
Task: tracking_shuffled_objects_five_objects
API: square_dance(initial_partners, switches):
  This function takes an initial list of pairs and a list
of
switches, and returns a dictionary representing the final
state of the pairs after performing the switches.
  initial_partners: A list of tuples, where each tuple
contains two elements representing a pair (e.g., [(“Alice”,
“goalkeeper”), (“Bob”, “left midfielder”), ...]). The
elements can be any type (e.g., strings, integers, etc.).
  switches: A list of tuples, where each tuple contains two
elements representing a pair of elements from the
initial partners list that will be switched (e.g.,
[(“Alice”, “Claire”), (“Alice”, “Bob”), ...]). The
elements should match the types used in the
initial_partners list.
  return: A dictionary representing the final state of the
pairs after performing the switches. The keys are the
first elements of the pairs in the initial_partners list,
and the values are the corresponding second elements
after performing the switches (e.g., {“Alice”: “right
winger”, “Bob”: “center midfielder”, ...}).
===
(Skip other tasks)
Here is a question:
{question}
According to the API documents above, you may find some
functions that can be used to solve the task, or, sometimes
there does not exist proper function to solve the task. Figure
out if there is function to solve the task and reply in the
format:
  Task: {{task}}
(reply unknown if no function can solve the question)
```

Although FIG. 3 illustrates dispatcher 300 as internal to second model system 110, it is to be understood that dispatcher 300 can execute on first model system 102, a tool cache system, an independent system, etc.

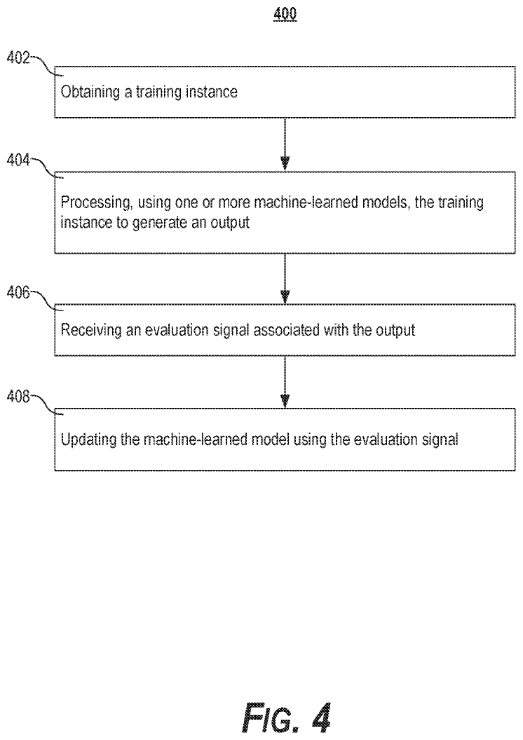

FIG. 4 depicts a flowchart of a method 400 for training one or more machine-learned models according to aspects of the present disclosure. For instance, an example machine-learned model can include a first model 106, a second model 112, a dispatcher model 300, etc.

One or more portion(s) of example method 400 can be implemented by a computing system that includes one or more computing devices such as, for example, computing systems described with reference to the other figures. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

At 402, example method 400 can include obtaining a training instance. A set of training data can include a plurality of training instances divided between multiple datasets (e.g., a training dataset, a validation dataset, or testing dataset). A training instance can be labeled or unlabeled. Although referred to in example method 400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 404, example method 400 can include processing, using one or more machine-learned models, the training instance to generate an output. The output can be directly obtained from the one or more machine-learned models or can be a downstream result of a chain of processing operations that includes an output of the one or more machine-learned models.

At 406, example method 400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 408, example method 400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 400 can include implementing a number of generalization techniques (e.g., weight decays, dropouts, etc.) to improve the generalization capability of the models being trained.

In some implementations, example method 400 can be implemented for training a machine-learned model from an initialized state to a fully trained state (e.g., when the model exhibits a desired performance profile, such as based on accuracy, precision, recall, etc.).

In some implementations, example method 400 can be implemented for particular stages of a training procedure. For instance, in some implementations, example method 400 can be implemented for pre-training a machine-learned model. Pre-training can include, for instance, large-scale training over potentially noisy data to achieve a broad base of performance levels across a variety of tasks/data types.

In some implementations, example method 400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 400 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 400 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

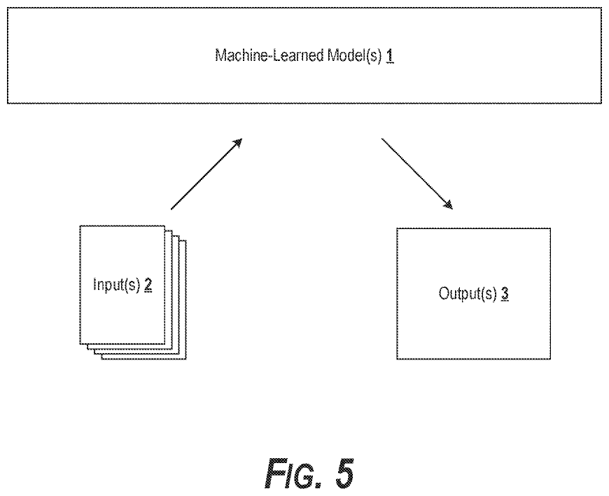

FIG. 5 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of a first model 106, a second model 112, a dispatcher model 300, etc. Although various features, variations, and implementations described below are described with respect to machine-learned model(s) 1, it is to be understood that such features, variations, and implementations are to be understood as described with respect to each of a first model 106, a second model 112, a dispatcher model 300, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

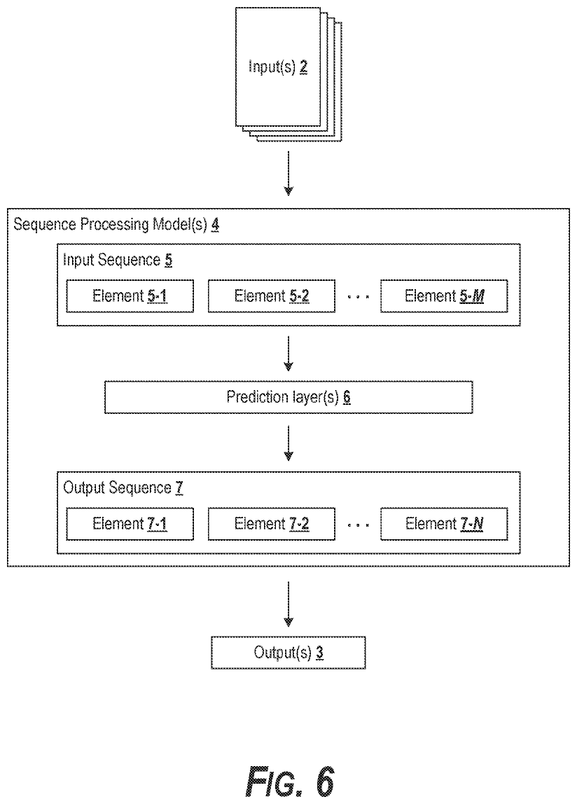

FIG. 6 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 6 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

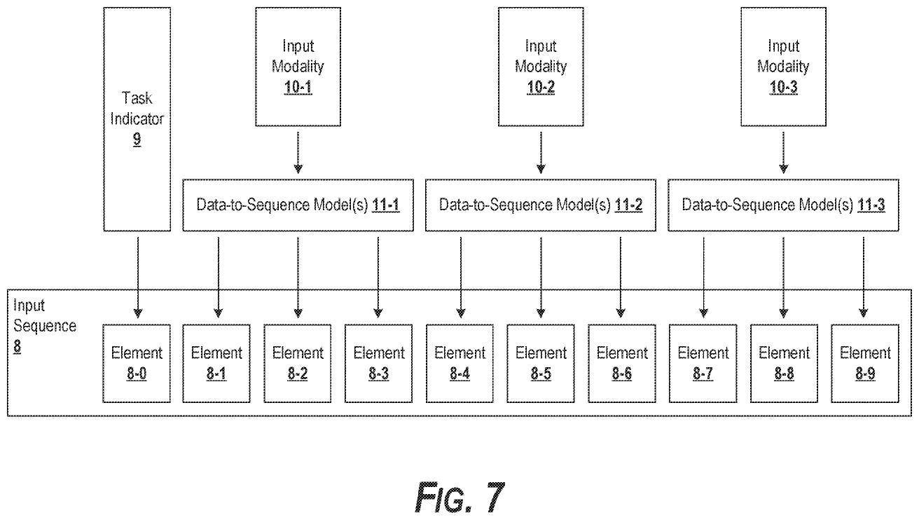

FIG. 7 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

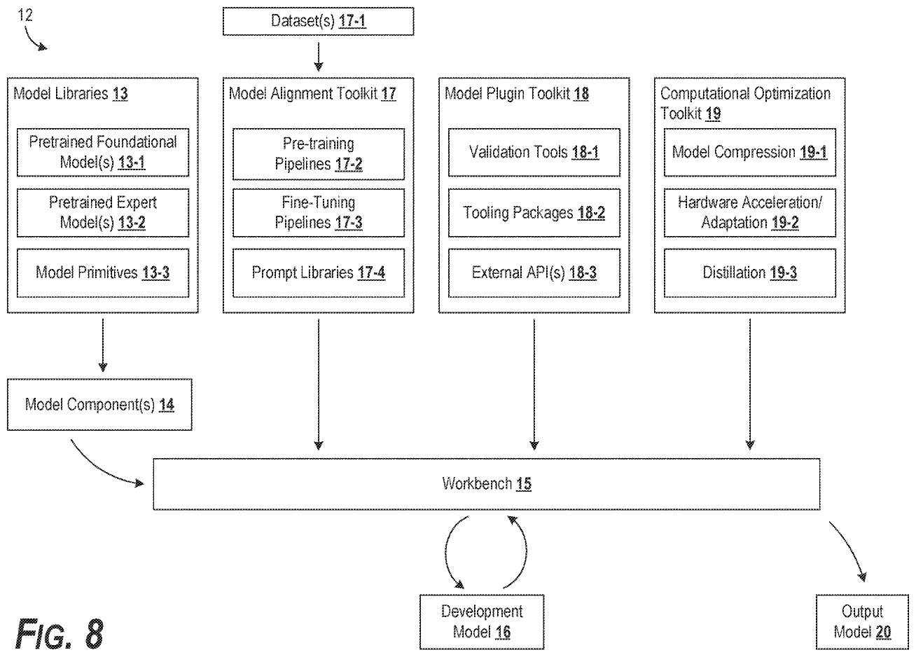

FIG. 8 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 400 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

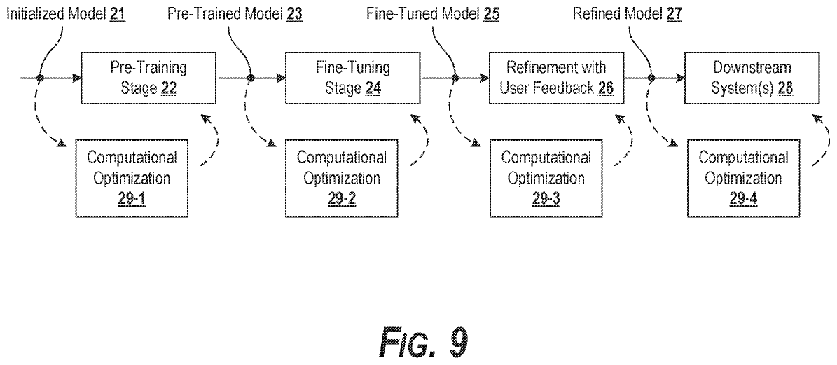

FIG. 9 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

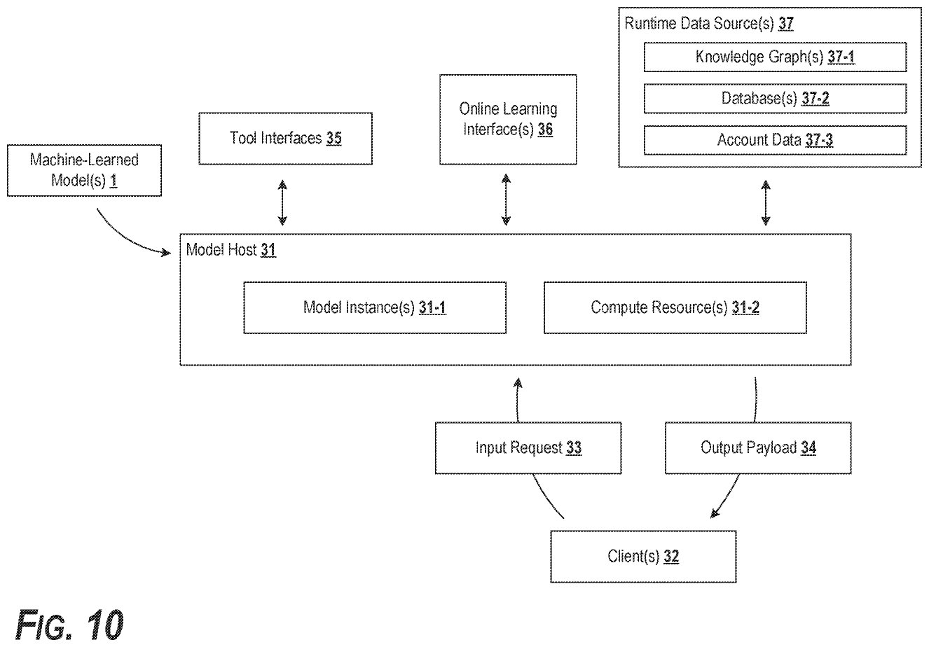

FIG. 10 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

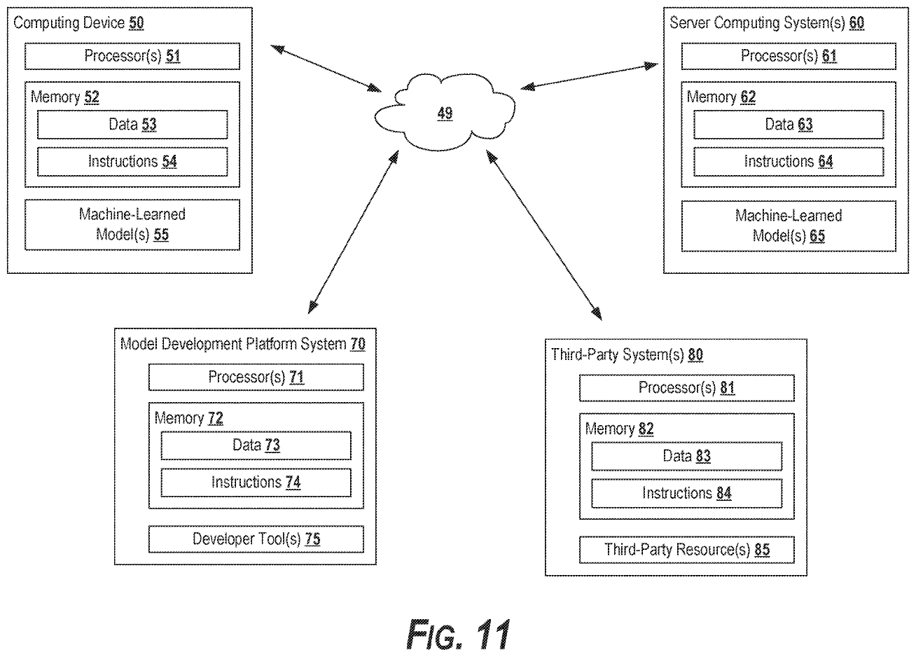

FIG. 11 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 11 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 11 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

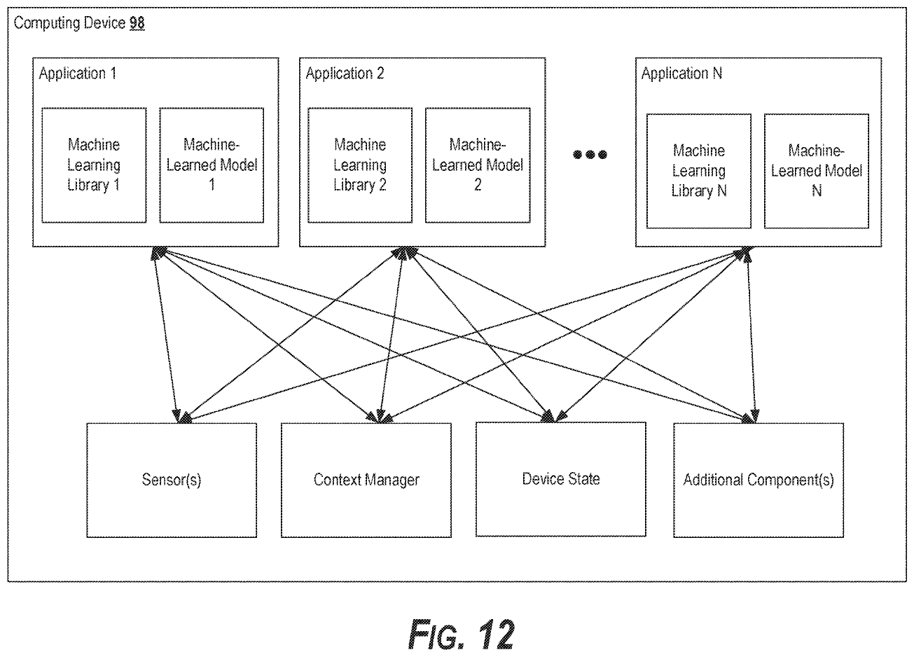

FIG. 12 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 12, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

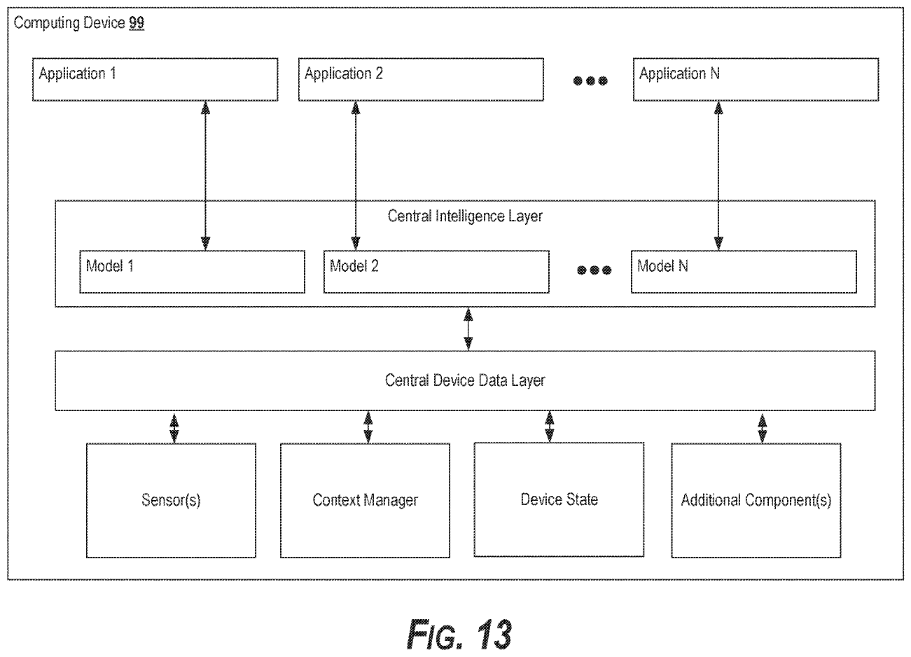

FIG. 13 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 13, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 13, the central device data layer can communicate with a number of other components of the computing device, such as, for example, one or more sensors, a context manager, a device state component, or additional components. In some implementations, the central device data layer can communicate with each device component using an API (e.g., a private API).

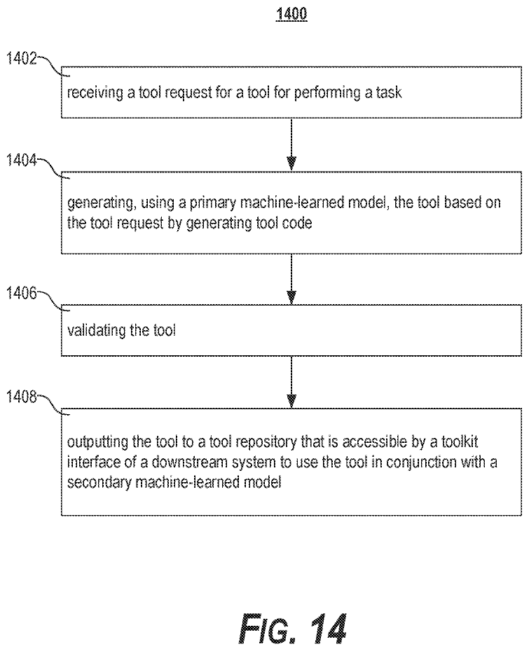

FIG. 14 depicts a flowchart of a method 1400 for generating tools using one or more machine-learned models according to aspects of the present disclosure. For instance, an example machine-learned model can include a first model 106.

One or more portion(s) of example method 1400 can be implemented by a computing system that includes one or more computing devices such as, for example, computing systems described with reference to the other figures. Each respective portion of example method 1400 can be performed by any (or any combination) of one or more computing devices. Moreover, one or more portion(s) of example method 1400 can be implemented on the hardware components of the device(s) described herein. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of example method 1400 can be performed additionally, or alternatively, by other systems.

At 1402, example method 1400 includes receiving a tool request for a tool for performing a task. For example, a tool request (e.g., tool request 104) can include a description of a task to be performed. The description can include example inputs or example outputs. The tool request may specify details such as the nature of the task, desired programming language for the tool, performance constraints, and specific algorithms or methodologies to be incorporated. For instance, the tool request could be for a Python function that automates data analysis tasks, where the request specifies the use of particular data analysis libraries and performance benchmarks such as execution speed or memory usage.

At 1404, example method 1400 includes generating, using a primary machine-learned model, the tool based on the tool request by generating tool code. In some implementations of example method 1400, the tool includes tool code written in a programming language. For example, first model 106 can process an input (e.g., a textual prompt) and generate computer code for tool code 108. The input can be based on tool request 104. The input can include all or a portion of tool request 104.

In some implementations of example method 1400, the tool request or the input includes one or more example inputs to the tool and one or more example outputs corresponding to the one or more example inputs. For instance, the tool request can specify that the tool should be capable of converting temperature readings from Celsius to Fahrenheit, with example inputs being specific temperature values in Celsius and example outputs being the corresponding Fahrenheit values. This explicit demonstration facilitates the primary machine-learned model's implementation of the desired functionality, helping it to generate tool code that accurately reflects the intended conversions. Further, by providing example inputs and outputs, the system can effectively validate the generated tool's performance by comparing its actual outputs against the expected outputs.

In some implementations of example method 1400, the tool request or the input includes one or more question-answer pairs. In some implementations of example method 1400, the tool request or the input includes one or more example tasks and example tool code corresponding to the one or more example tasks (e.g., a single-shot or few-shot prompt for tool code generation).

In some implementations, example method 1400 includes sampling a plurality of outputs from the primary machine-learned model to obtain a plurality of generated tools. For example, first model 106 can generate a plurality of different candidate tool code objects (e.g., batchwise, in parallel). In some implementations, example method 1400 includes evaluating the plurality of generated tools. In some implementations, example method 1400 includes selecting, by the computing system, the tool based on the evaluation of the plurality of generated tools.

For example, if the task involves generating a scheduling function for meetings, the primary machine-learned model might generate several variations of Python functions, each with different logic or parameters. These variations can be sampled and stored temporarily in memory. The plurality of generated tools can then be evaluated based on predefined criteria such as efficiency, accuracy, or computational cost. This evaluation can occur in a tool execution environment 116, which might simulate or run the tools to observe their performance in real or near-real operational settings. The best-performing tool or tools can then be selected and validated, possibly using validation samples that demonstrate how to convert a task into a function call, as described in the tool verification process. This sampling and selecting process allows the computing system to optimize the tool creation by choosing the most effective tool or tools from a set of candidates generated by the primary machine-learned model, thereby enhancing the overall efficiency and effectiveness of the tool-making stage.

At 1406, example method 1400 includes validating the tool. For example, first model system 102 can validate a tool code 108 output by first model 106. In some implementations of example method 1400, the primary machine-learned model debugs the tool using the example inputs and the example outputs in the tool request. First model 106 can generate one or more units tests (or apply one or more pre-made unit tests) to validate the tool code.

In some implementations, example method 1400 includes converting the validation samples into unit tests. In some implementations of example method 1400, the primary machine-learned model generates unit tests using validation samples and executes these tests on the generated tool. For example, a validation sample can include a known input-output pairing. First model system 102 can execute the tool code for the known input and evaluate the returned output against the known output. In some implementations of example method 1400, the validation samples demonstrate how to formulate a tool input for the task.

In some implementations, example method 1400 includes converting, using the primary machine-learned model, the validation samples into unit tests. For instance, provided a set of validation samples, first model system 102 can query first model 106 to generate unit tests based on the set of validation samples.

In some implementations of example method 1400, in response to a failure for any of the unit tests, the failure is recorded in a log and the log is input to the primary machine-learned model along with the tool code to cause the primary machine-learned model to attempt to rectify a cause of the failure. For instance, a follow-up input to first model 106 can include a request to correct a bug in tool code 108 (e.g., an execution failure identified on a particular line). The follow-up input can include any error messages generated by the execution runtime.

At 1408, example method 1400 includes outputting the tool to a tool repository that is accessible by a toolkit interface of a downstream system to use the tool in conjunction with a secondary machine-learned model.

For instance, the tool code 108, once generated and validated, can be stored in a tool cache 200 that acts as the tool repository. This tool cache can be part of a server computing system (e.g., the same system as or a different system from a system that hosts the primary machine-learned model). Toolkit interface 114 of one or more client systems (e.g., second model system 110) can access this tool cache to retrieve tools as needed. The tool can be utilized by a secondary machine-learned model, which might be a smaller or less computationally expensive model compared to the primary model, to perform specific tasks more efficiently. This setup allows the secondary model to leverage complex tools created by the more powerful primary model without incurring the computational cost associated with generating those tools or needing sufficient expressive power to directly compute the requested task without a tool.

In some implementations, example method 1400 includes packaging, by the computing system, the tool with data for a prompt demonstrating how to formulate a tool input for the task. The data for the prompt can include specific instructions or code snippets that guide the secondary machine-learned model on how to correctly formulate inputs for the tool, ensuring the tool is applied correctly and efficiently. For example, the prompt could demonstrate how to convert parameters from a user query received by a client device into a structured format that the tool can process. This might involve transforming natural language inputs into a series of function calls or adjusting data formats to match the tool's requirements. The packaged tool, along with its accompanying prompt data, can be stored in a tool repository accessible via a toolkit interface (e.g., toolkit interface 114), which manages the interaction between the tool and the secondary model. This setup allows for a streamlined integration where the secondary model can retrieve the tool and its usage instructions seamlessly, facilitating a more efficient handling of tasks and reducing the computational load on the secondary model by leveraging pre-packaged, task-specific tools.

In some implementations of example method 1400, the primary machine-learned model includes a sequence processing model. An example sequence processing model receives an input sequence and generates an output sequence.

In some implementations of example method 1400, the secondary machine-learned model includes a sequence processing model. An example sequence processing model receives an input sequence and generates an output sequence.

In some implementations of example method 1400, the primary machine-learned model is a larger model than the secondary machine-learned model. For instance, in some implementations of example method 1400, the primary machine-learned model has more parameters than the secondary machine-learned model. In some implementations of example method 1400, the primary machine-learned model is more computationally expensive to execute than the secondary machine-learned model.

In some implementations of example method 1400, the primary machine-learned model is implemented on a server computing system and the secondary machine-learned model is implemented on a client device that is in a client-server relationship with the server computing system.

In some implementations of example method 1400, the primary machine-learned model is implemented on a server computing system and the secondary machine-learned model is implemented on the server computing system.

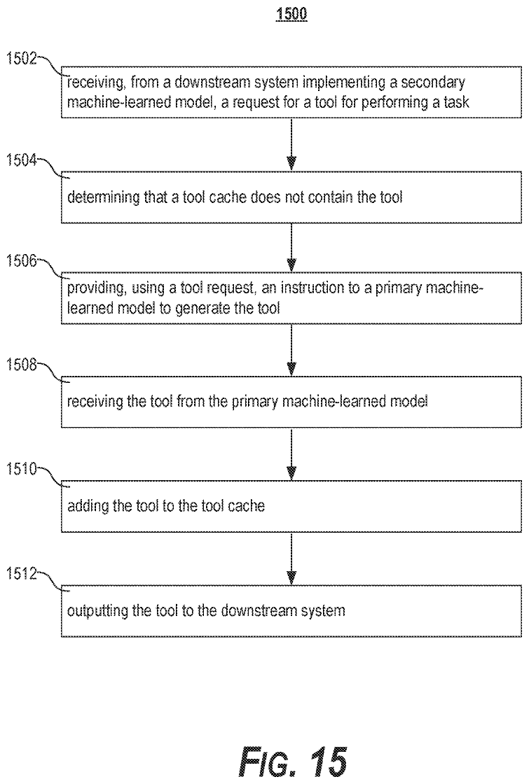

FIG. 15 depicts a flowchart of a method 1500 for obtaining and distributing tools according to aspects of the present disclosure.

One or more portion(s) of example method 1500 can be implemented by a computing system that includes one or more computing devices such as, for example, computing systems described with reference to the other figures. Each respective portion of example method 1500 can be performed by any (or any combination) of one or more computing devices. Moreover, one or more portion(s) of example method 1500 can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of example method 1500 can be performed additionally, or alternatively, by other systems.

At 1502, example method 1500 includes receiving, from a downstream system implementing a secondary machine-learned model, a request for a tool for performing a task. The request can be received by a dispatcher system (e.g., dispatcher 300), first model system 102, etc.

At 1504, example method 1500 includes determining that a tool cache does not contain the tool. This determination can be based on a query over the cache, such as a query against a list of tool names, tool descriptions, tool embeddings (e.g., a characteristic vector generated by embedding one or more attributes associated with the tool), etc. In some implementations of example method 1500, the dispatcher queries the tool cache for available tools. In some implementations of example method 1500, a dispatcher queries the tool cache based on a similarity measure between an input to the secondary model system and a characteristic vector associated with tools in the tool cache.

If tool is available, in some implementations, example method 1500 includes selecting, by the computing system and using a dispatcher, the tool for the task. In some implementations of example method 1500, the dispatcher includes a machine-learned model. For example, the results of a query over the tool cache (e.g., a top-K listing of results) can be input to a dispatcher model (e.g., a sequence processing model) along with an instruction to return an appropriate tool for the task.

Determining that a tool cache does not contain the tool can include not obtaining any query results that have above a threshold match score. Determining that a tool cache does not contain the tool can include not obtaining any query results that align with a provided set of match criteria (e.g., input format, output format, runtime, memory footprint, etc.).

At 1506, example method 1500 includes providing, using a tool request, an instruction to a primary machine-learned model to generate the tool. For instance, second model system 110 or dispatcher 300 (e.g., a dispatcher system operating on second model system 110 or separate from second model system 110) can issue a tool request (e.g., tool request 104) to first model system 102.

At 1508, example method 1500 includes receiving the tool from the primary machine-learned model. The received tool can include tool code 108 wrapped with metadata, such as instructions or prompts for implementing or invoking the tool, a list of dependencies, etc.

At 1510, example method 1500 includes adding the tool to the tool cache.

At 1512, example method 1500 includes outputting the tool to the downstream system. The downstream system can implement a secondary machine-learned model. In some implementations of example method 1500, the secondary machine-learned model includes a sequence processing model. An example sequence processing model receives an input sequence and generates an output sequence.

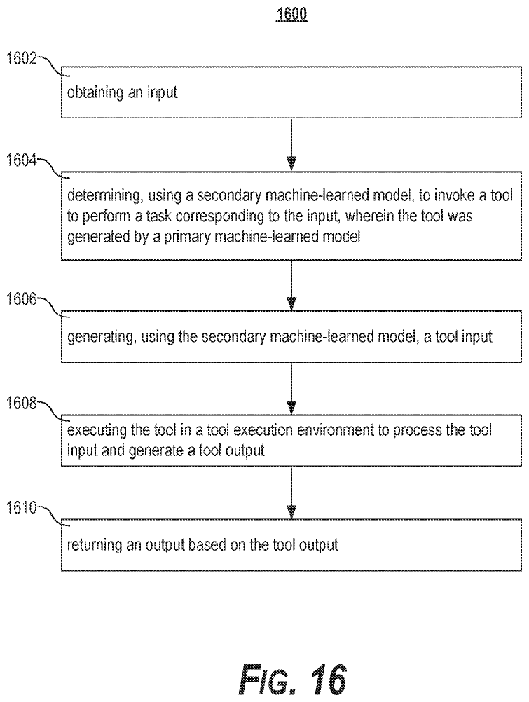

FIG. 16 depicts a flowchart of a method 1600 for using tools using one or more machine-learned models according to aspects of the present disclosure. For instance, an example machine-learned model can include a second model 112.

One or more portion(s) of example method 1600 can be implemented by a computing system that includes one or more computing devices such as, for example, computing systems described with reference to the other figures. Each respective portion of example method 1600 can be performed by any (or any combination) of one or more computing devices. Moreover, one or more portion(s) of example method 1600 can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of example method 1600 can be performed additionally, or alternatively, by other systems.

At 1602, example method 1600 includes obtaining an input. For instance, second model system 110 can obtain an input. The input can be diverse in nature, ranging from textual data, image data, audio data, or any combination thereof. For instance, a computing device might receive natural language text as input through a user interface, which could involve a user typing a request or a query into a text field. Alternatively, a computing system might obtain input data from a network, where the data could be transmitted from third-party system(s) or from another server or client within a cloud infrastructure. The input could also include sensor data from IoT devices or input fetched from a database or a live data stream.

At 1604, example method 1600 includes determining, using a secondary machine-learned model, to invoke a tool to perform a task corresponding to the input, wherein the tool was generated by a primary machine-learned model. For instance, the secondary machine-learned model can generate, based on processing the input, an output sequence that indicates a tool is desired to perform a task. The output sequence can include tool request 104. The output sequence can include a flag or other indicator that a tool would be helpful or needed.

In some implementations, example method 1600 includes querying a tool cache populated by available tools. If the cache contains a relevant tool for the task, the system can retrieve the tool. If the cache does not contain a relevant tool for the task, the cache system can engage first model system 102 to generate the tool.

In some implementations, example method 1600 includes receiving the tool. For instance, second model system 110 receives the tool code 108 from tool cache 200.

At 1606, example method 1600 includes generating, using the secondary machine-learned model, a tool input. For example, second model 112 can process an input that describes an input format for the tool to generate an input for the tool to perform the task. In some implementations, example method 1600 includes inputting, into the secondary machine-learned model, tool code associated with the tool. Inputting the tool code can illustrate an expected input format for invoking the tool. In some implementations, example method 1600 includes inputting (e.g., to second model 112) a prompt demonstrating how to formulate a tool input for the task.

In some implementations, example method 1600 includes obtaining, from the tool cache, a prompt demonstrating how to formulate a tool input for the task.

In some implementations, example method 1600 includes inputting, into the secondary machine-learned model, a tool index describing a list of available tools for the secondary machine-learned model to use. In some implementations, example method 1600 includes obtaining an output from the secondary machine-learned model that indicates selection of the tool from the available tools and the tool input.

In some implementations, example method 1600 includes generating, using the secondary machine-learned model, code that calls the tool. For instance, secondary machine-learned model can generate a lightweight script or command to execute in execution environment 116 to invoke the tool.

In some implementations of example method 1600, a tool interface parses outputs of the secondary machine-learned model to initiate execution of the tool or execution of a program calling the tool. For instance, second machine-learned model 112 can output text. The text can include textual commands. The commands can be formatted in, for instance, JSON or other structured output formats. Tool interface 114 can parse the textual output (e.g., using regular expressions, JSON object parsing tools, etc.) to identify a tool call or command.

At 1608, example method 1600 includes executing the tool in a tool execution environment to process the tool input and generate a tool output (e.g., environment 116).

At 1610, example method 1600 includes returning an output based on the tool output. For example, the tool can output data to memory, write data to disk/storage, transmit data to an API endpoint, etc. In some implementations of example method 1600, a tool interface returns the tool output for input to the secondary machine-learned model.

In some implementations of example method 1600, a log is maintained with inputs to and outputs of the secondary machine-learned model, the tool, the program calling the tool, or combinations thereof, and wherein the secondary machine-learned model processes the log with one or more successive inputs. For instance, secondary machine-learned model can process a transcript of a multi-turn dialog between a user, a tool, and the model's own outputs.

In some implementations of example method 1600, the secondary machine-learned model processes tool code associated with the tool. In some implementations of example method 1600, the secondary machine-learned model processes example code that calls the tool.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A method comprising:
receiving, by a computing system, a tool request for a tool for performing a task;
generating, by the computing system and using a primary machine-learned model, the tool based on the tool request by generating tool code;
validating, by the computing system, the tool; and
outputting, by the computing system, the tool to a tool repository that is accessible by a toolkit interface of a downstream system to use the tool in conjunction with a secondary machine-learned model.

2. A method comprising:
receiving, by a computing system and from a downstream system implementing a secondary machine-learned model, a request for a tool for performing a task;
determining, by the computing system, that a tool cache does not contain the tool;
providing, by the computing system and using a tool request, an instruction to a primary machine-learned model to generate the tool;
receiving, by the computing system, the tool from the primary machine-learned model;
adding, by the computing system, the tool to the tool cache; and
outputting, by the computing system, the tool to the downstream system.

3. A method comprising:
obtaining, by a computing system, an input;
determining, by the computing system and using a secondary machine-learned model, to invoke a tool to perform a task corresponding to the input, wherein the tool was generated by a primary machine-learned model;
generating, by the computing system and using the secondary machine-learned model, a tool input;
executing, by the computing system, the tool in a tool execution environment to process the tool input and generate a tool output; and
returning, by the computing system, an output based on the tool output.

4. The method of claim 1, comprising:
sampling, by the computing system, a plurality of outputs from the primary machine-learned model to obtain a plurality of generated tools;
evaluating, by the computing system, the plurality of generated tools; and
selecting, by the computing system, the tool based on the evaluation of the plurality of generated tools.

5. The method of claim 1, wherein the primary machine-learned model generates unit tests using validation samples and executes these tests on the generated tool.

6. The method of claim 5, wherein, in response to a failure for any of the unit tests, the failure is recorded in a log and the log is input to the primary machine-learned model along with the tool code to cause the primary machine-learned model to attempt to rectify a cause of the failure.

7. The method of claim 5, wherein the validation samples demonstrate how to formulate a tool input for the task.

8. The method of claim 5, comprising:
converting, by the computing system, the validation samples into unit tests.

9. The method of claim 5, comprising:
converting, by the computing system and using the primary machine-learned model, the validation samples into unit tests.

10. The method of claim 5, wherein the validation samples demonstrate how to formulate a tool input for the task.

11. The method of claim 1, comprising:
packaging, by the computing system, the tool with data for a prompt demonstrating how to formulate a tool input for the task.

12. The method of claim 3, comprising:
inputting, by the computing system and into the secondary machine-learned model, tool code associated with the tool.

13. The method of claim 3, comprising:
inputting, by the computing system, a prompt demonstrating how to formulate a tool input for the task.

14. The method of claim 3, comprising:
generating, by the computing system and using the secondary machine-learned model, code that calls the tool; and
executing, by the computing system, the code.

15. The method of claim 3, wherein a tool interface parses outputs of the secondary machine-learned model to initiate execution of the tool.

16. The method of claim 3, wherein a tool interface parses outputs of the secondary machine-learned model to initiate execution of a program calling the tool.

17. The method of claim 3, wherein a tool interface returns the tool output for input to the secondary machine-learned model.

18-20. (canceled)

21. The method of claim 3, comprising:
querying, by the computing system, a tool cache populated by available tools; and
receiving, by the computing system, the tool.

22. (canceled)

23. The method of claim 3, comprising:
inputting, by the computing system and into the secondary machine-learned model, a tool index describing a list of available tools for the secondary machine-learned model to use; and
obtaining, by the computing system, an output from the secondary machine-learned model that indicates selection of the tool from the available tools and the tool input.

24. The method of claim 3, wherein the tool request comprises one or more example inputs to the tool and one or more example outputs corresponding to the one or more example inputs.

25-44. (canceled)
